(19) United States
(12) Patent Application Publication
(10) Pub. No.: US 2007/0108651 A1
(43) Pub. Date: May 17, 2007

(54) Decorative member

(75) Inventor: Yasuyuki Suzuki, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Chiyoda-ku , Tokyo (JP)

(21) Appl. No.: 10/559,340

(22) PCT Filed: Jul. 15, 2004
(86) PCT No.: PCT/JP04/10107

§ 371 Date: Dec. 5, 2005

(51) Int. Cl. D04H 11/00; B32B 33/00

(52) U.S. Cl. 264/171.11; 156/90; 428/85

(57) ABSTRACT

In a decorative member, a paint layer containing a frosting paint for creating a frosted state during its curing is formed on a design face of a base member. The frosting paint is applied as a large number of dots. A pattern is formed on the paint layer by changing the application density of the frosting paint.

### TECHNICAL FIELD

The present invention relates to a decorative member for use in, for example, a door panel or a cage wall panel of an elevator.

### BACKGROUND ART

In a conventional sandblasting technique, a masking material (photomask) is attached to a base member to be worked such as glass or ceramic with a view to obtaining a worked face of a predetermined shape. (e.g., see-Patent Document 1).

However, such a technique requires films and developing agents each time. Also, cleaning with water involves generation of waste fluid. Thus, there have been demands for a countermeasure against adverse impacts on the environment.

Although there has been also proposed a method of performing sandblasting without using any masking material (e.g., see Patent Document 2), this method requires too much time to treat a large area. Further, the diameter of abrasive particles ranges approximately from 100 μm to several millimeters, so sufficient accuracy cannot be guaranteed in forming a pattern by means of sandblasting.

Patent Document 1: JP 10-138142 A

Patent Document 2: JP 10-560 A

### DISCLOSURE OF THE INVENTION

### Problems to be Solved by the Invention

As described above, the conventional working methods necessitates a countermeasure against adverse impacts on the environment. This countermeasure takes a lot of time and effort.

The present invention is made to solve the problems described above. It is thus an object of the invention to obtain a decorative member with an artistically accomplished design while sufficiently suppressing adverse impacts on the environment.

Means for Solving the Problems

To this end, according to one aspect of the present invention, there is provided a decorative member comprising: a base member having a design face; and a paint layer formed on the design face and containing a frosting paint for creating a frosted state during curing thereof, wherein the frosting paint is applied as a large number of dots; and the frosting paint is changed in application density to form a pattern on the paint layer.

### BRIEF DESCRIPTION OF THE DRAWINGS

FIG. 1 is a front view showing a decorative member according to Embodiment 1 of the present invention.

FIG. 2 is an enlarged illustrative view showing a first example of a state of application of the frosting paint to the uniform region of FIG. 1.

FIG. 3 is an enlarged illustrative view showing a second example of a state of application of the frosting paint to the uniform region of FIG. 1.

FIG. 4 is an illustrative chart showing a result of a comparative experiment in which degrees of finish resulting from different application methods of the frosting paint are compared with one another.

FIG. 5 is an illustrative view showing another example of a method of applying the frosting paint according to Embodiment 1.

FIG. 6 is an illustrative view showing still another example of the method of applying the frosting paint according to Embodiment 1.

FIG. 7 is an illustrative view showing yet another example of the method of applying the frosting paint according to Embodiment 1.

FIG. 8 is a schematic diagram showing a first example of a printing system for applying the frosting paint of FIG. 1.

FIG. 9 is a schematic diagram showing a second example of a printing system for applying the frosting paint of FIG. 1.

FIG. 10 is a perspective view showing how a base member 1 is inserted into the printer of FIG. 9.

FIG. 11 is a side view showing essential parts of the printer body of FIG. 9.

FIG. 12 is a side view showing how air is sprayed onto the base member of FIG. 11.

FIG. 13 is a side view showing how a paint is applied to the base member of FIG. 12 and ultraviolet rays are radiated.

FIG. 14 is a sectional view showing a decorative member according to Embodiment 2 of the present invention.

FIG. 15 is a sectional view showing another method of applying the frosting paint of FIG. 14.

FIG. 16 is a sectional view showing a decorative member according to Embodiment 3 of the present invention.

### BEST MODES FOR CARRYING OUT THE INVENTION

Preferred embodiments of the present invention will be described hereinafter with reference to the drawings.

### Embodiment 1

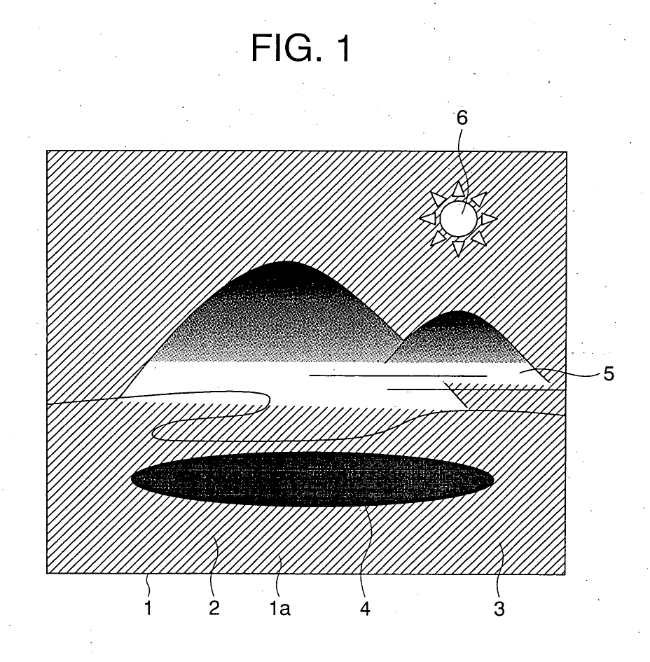

FIG. 1 is a front view showing a decorative member according to Embodiment 1 of the present invention. Referring to this figure, a base member 1 is made of a metal panel. Usable as this metal are, for example, a stainless steel, aluminum, an aluminum alloy, a magnesium alloy, titanium, or a titanium alloy.

The base member 1 has a design face 1a. Only one of a plurality of faces constituting the base member 1 may be used as a design face 1a or some of those faces may be used as design faces 1a. Each design face 1a is polished to enhance glossiness thereof.

A paint layer 2 is formed on the design face 1a by applying a paint thereto. The paint layer 2 includes a transparent frosting paint region that is frosted as a frosting paint cures, and a normal transparent paint region to which a normal transparent paint different from the frosting paint is applied.

The surface of the frosting paint is not smoothened even after its curing, and forms a three-dimensional painted surface having slight elevations corresponding to respective particles. The frosting paint is cured by, for example, being irradiated with ultraviolet rays. Specific examples of the frosting paint are disclosed in, for example, JP 6-312495 A and Japanese Patent No. 3004897.

The frosting paint and the transparent paint are applied as a large number of dots. A pattern (picture or figure) is formed on the paint layer 2 by changing the application density of the frosting paint. The pattern (picture or figure) is formed on the paint layer 2 also through combination of the frosting paint region and the transparent paint region.

More specifically, the transparent paint is applied to a translucent region 3 indicated by oblique lines in FIG. 1. In the translucent region 3, the design face 1a of the base member 1 as a background is visible through the paint layer 2. The frosting paint is applied to a uniform region 4 of FIG. 1 with a constant dot density (application density). The pattern in a change region 5 of FIG. 1 is gradated by continuously changing the dot density of the frosting paint. The frosting paint is applied to a low-density region 6 of FIG. 1 uniformly but less densely (coarsely) than to the uniform region 4.

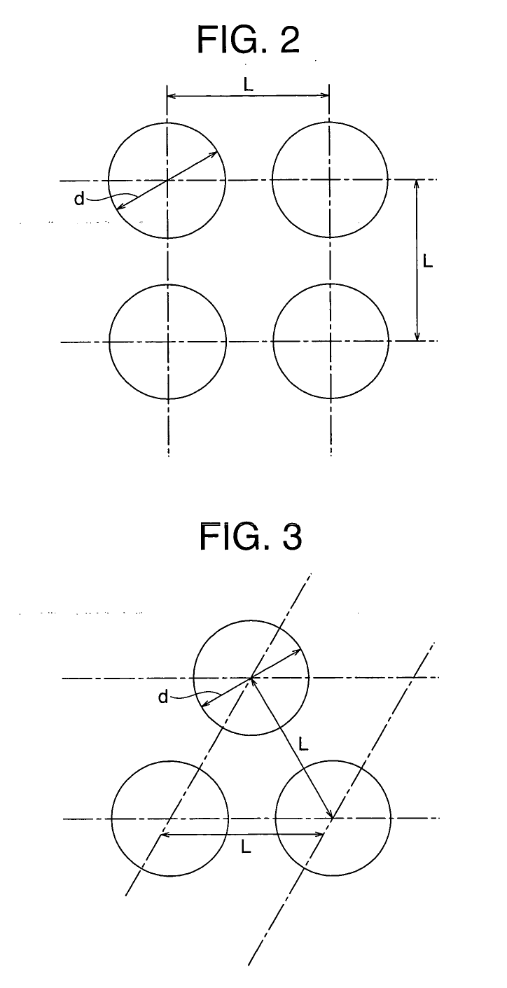

FIG. 2 is an enlarged illustrative view showing a first example of a state of application of the frosting paint in the uniform region 4 of FIG. 1. FIG. 3 is an enlarged illustrative view showing a second example of a state of application of the frosting paint in the uniform region 4 of FIG. 1. Referring to FIG. 2, a plurality of centerlines passing through the centers of respective dots intersect with one another at right angles. Referring to FIG. 3, a plurality of centerlines passing through the centers of respective dots intersect with one another at predetermined angles other than right angles. Referring to FIGS. 2 and 3, d and L denote the diameter of the dots and the distance between centers of the dots, respectively.

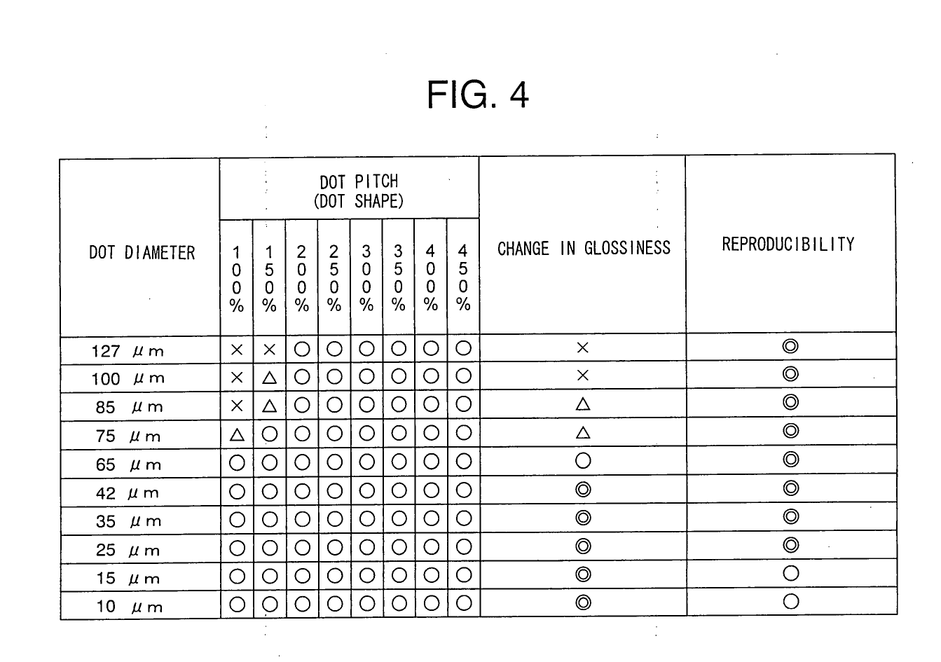

FIG. 4 is an illustrative chart showing a result of a comparative experiment in which degrees of finish resulting from different application methods of the frosting paint are compared with one another. In this experiment, a subjective evaluation was made as to the change in glossiness and the reproducibility of glossiness. It should be noted in the result of this evaluation that each double circle means “very good”, that each circle means “good”, that each triangle means “somewhat problematic”, and that each X mark means “unserviceable”.

In the experiment, the degrees of finish were evaluated by changing the condition of a combination of a dot diameter and a dot pitch. The dot pitch represents a ratio of the distance between the centers of the dots to the dot diameter. For instance, a dot pitch of 200% means that the distance L between the dots in FIGS. 2 and 3 is twice as long as the dot diameter d.

As shown in FIG. 4, an increase in dot diameter leads to stable reproducibility but makes it impossible to confirm a change in glossiness. In contrast, a visually recognizable change in glossiness becomes obvious in accordance with a decrease in dot diameter. It has also been confirmed that an increase in dot diameter brings about fusion of adjacent dots prior to the curing of the frosting paint and thus makes it impossible to ensure a dot pitch.

It is therefore preferable to set the dot diameter of the frosting paint equal to or smaller than 65 μm. Further, it is preferable to apply the frosting paint so that the distance between the centers of adjacent dots becomes larger than the dot diameter and equal to or smaller than 300% thereof.

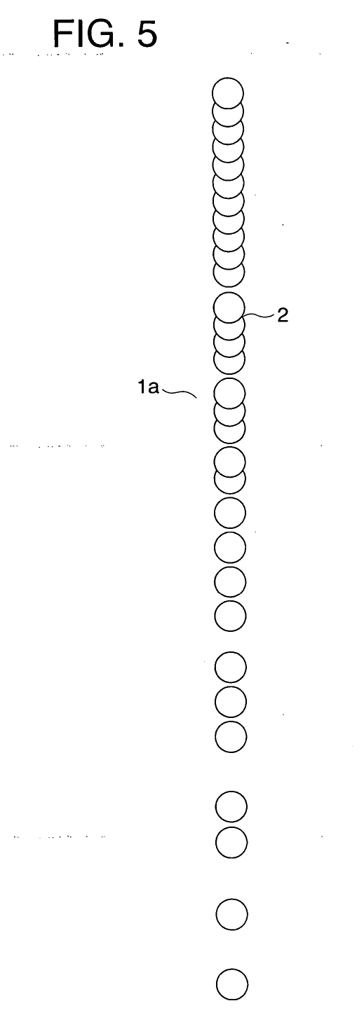

Reference is then made to FIG. 5, which is an illustrative view showing another example of a method of applying the frosting paint according to Embodiment 1. In the example of FIG. 5, the frosting paint is applied linearly. Thus, a linear pattern of the frosting paint is drawn on the design face 1a. A gradational expression is made possible by gradually changing the distance between the centers of adjacent dots.

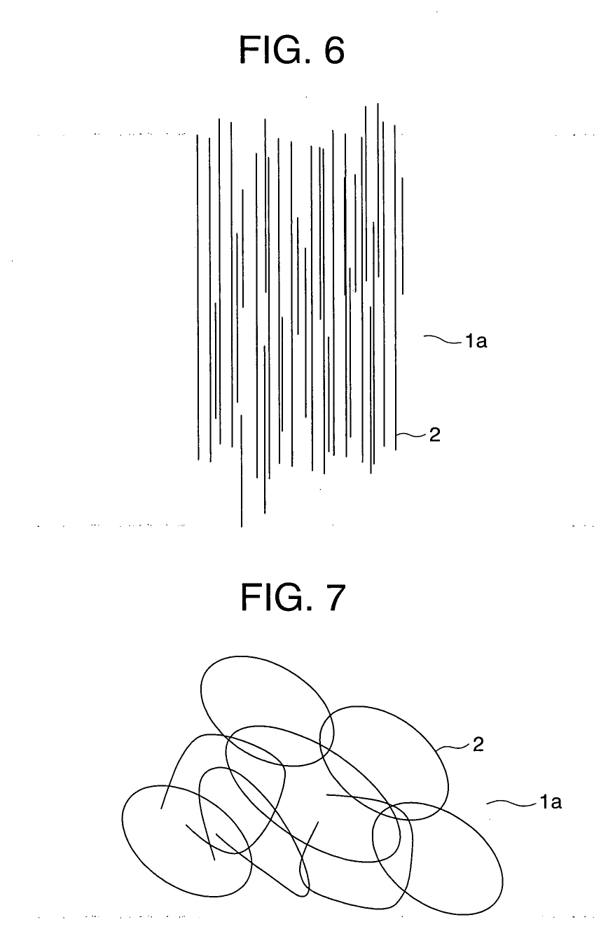

FIG. 6 is an illustrative view showing still another example of the method of applying the frosting paint according to Embodiment 1. In the example of FIG. 6, the frosting paint is applied in the form of a plurality of straight lines arranged apart from and parallel to one another. A finish similar to that of hairline machining can be obtained by thus drawing a plurality of straight lines using the frosting paint.

Further, FIG. 7 is an illustrative view showing yet another example of the method of applying the frosting paint according to Embodiment 1. In the example of FIG. 7, the frosting paint is applied in the form of a plurality of curves. The frosting paint is also applied in the form of a plurality of circles overlapping with one another. A finish similar to that of scratching can be obtained by thus drawing a plurality of curves using the frosting paint.

In the decorative member described above, the frosting paint is applied as a large number of dots, and a pattern is formed on the paint layer 2 by changing the application density of the frosting paint. Therefore, waste fluid containing chrome and nickel, a large amount of dust due to sandblasting, waste water and waste materials, various solvents as a result of the manufacture of a masking material can be prevented from being generated, and a decorative member with an artistically accomplished design can be obtained while sufficiently reducing adverse impacts on the environment.

The pattern is formed on the paint layer 2 also through combination of the frosting paint region 4, 5, or 6 and the transparent paint region 3. Thus, a decorative member with a more varied design of high artistic quality can be obtained.

Moreover, the design face 1a as the background of the paint layer 2 is polished to enhance glossiness thereof, so a finish providing a feeling of good quality is achieved through effective use of metallic luster of the design face 1a.

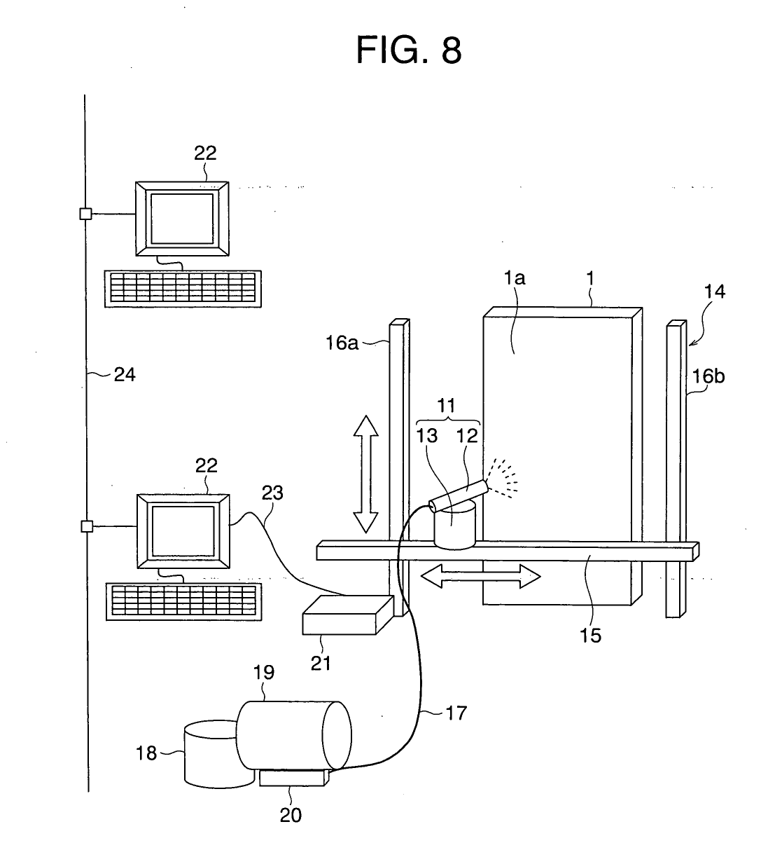

Reference is then made to FIG. 8, which is a schematic diagram showing a first example of a printing system for applying the frosting paint of FIG. 1. A paint injection unit 11 has a nozzle portion 12 for applying the frosting paint to the base member 1 through injection and an angle adjustment portion 13 for adjusting the angle of the nozzle portion 12 with respect to the base member 1. The paint injection unit 11 is further provided with a discharge amount control portion (not shown) for controlling the discharge amount of the frosting paint. The paint injection unit 11 is supported by a drive unit 14.

The drive unit 14 has a first position control rail 15 for guiding a movement of the paint injection unit 11 in a primary scanning direction (laterally in FIG. 8) and a pair of second position control rails 16a and 16b for guiding movements of the paint injection unit 11 and the first position control rail 15 in a secondary scanning direction. The drive unit 14 is further provided with a pulse motor (not shown), a wire (not shown), and the like for driving.

A paint tank 18 and an air tank 19 are connected to the paint injection unit 11 via a flexible feed tube 17. The frosting paint is accommodated in the paint tank 18. A feed control portion 20 controls the feed amount of the frosting paint and the pressure in the air tank 19.

A printer control portion 21 controls the discharge amount control portion of the paint injection unit 11 and the drive unit 12. A computer 22 such as a personal computer controls the printer control portion 21. The printer control portion 21 is connected to the computer 22 via a control cable 23. The computer 22 is connected to a network 24 to which a plurality of other computers 22 are connected.

Next, a method of manufacturing a decorative member using the printing system of FIG. 8 will be described. First, the base member 1 is set at a predetermined position so that the design face 1a faces the nozzle portion 12. A pattern to be recorded on the design face 1a is created using graphic-type software on the computer 22.

After that, the created pattern is converted into a predetermined control signal on the computer 22. This control signal is outputted to the printer control portion 21. When the control signal is inputted to the printer control portion 21, the position of the nozzle portion 12 is controlled by controlling the drive unit 12. Also, the discharge amount control portion for controlling the discharge amount of the frosting paint is controlled to ensure a suitable dot diameter.

The transparent paint is applied using a common printer designed to selectively change the paint type. However, the transparent paint can also be applied using another printer after the frosting paint has been applied.

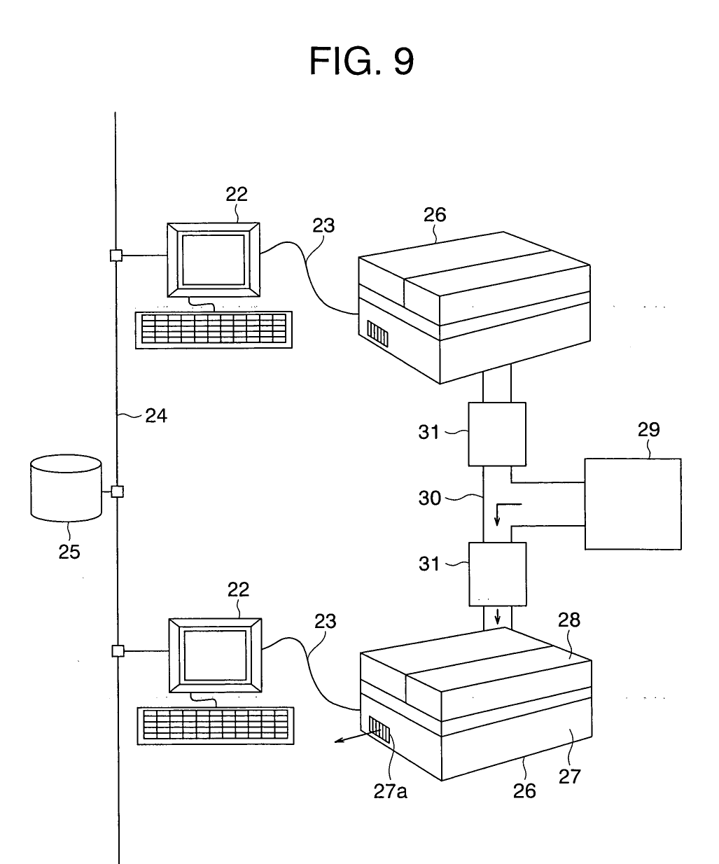

Reference is then made to FIG. 9, which is a schematic diagram showing a second example of a printing system for applying the frosting paint of FIG. 1. Referring to the figure, a plurality of computers 22 and a server 25 are connected to the network 24. A printer 26 is connected to each of the computers 22 via the control cable 23.

An inkjet printer is used as the printer 26. Each printer 26 has a printer body 27 and an openable and closable cover 28. A lateral face of the printer body 27 is provided with an exhaust port 27a.

A clean unit 29 for taking in and purifying air (removing dust therefrom) is connected to the printer 26 via a duct 30. The air taken in and purified by the clean unit 29 is introduced into the printer 26 via the duct 30. Provided between the clean unit 29 and each printer 26 is a pressure adjustment unit 31 for adjusting the pressure of air introduced into the printer 26.

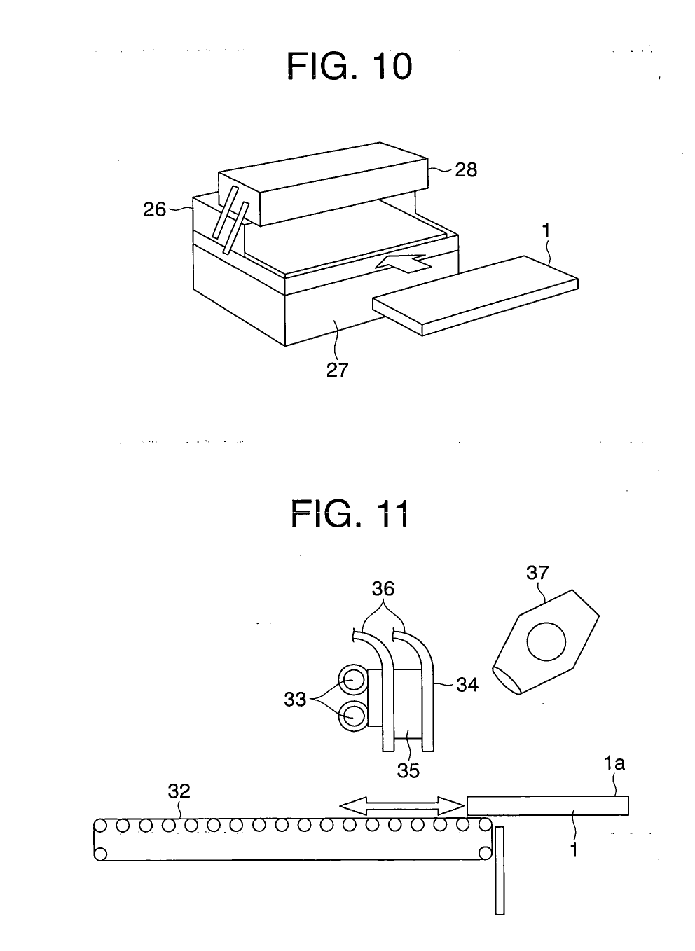

FIG. 10 is a perspective view showing how the base member 1 is inserted into the printer 26 of FIG. 9. As shown in FIG. 10, the base member 1 can be set at a predetermined position within the printer 26 by opening the cover 28.

FIG. 11 is a side view showing essential parts of the printer body 27 of FIG. 9. The printer body 27 is provided with a conveyance table 32 for supporting the base member 1 horizontally and causing it to reciprocate in the secondary scanning direction (laterally in the figure). A pair of head guide rails 33 are arranged horizontally above the conveyance table 32.

A printer head 34 is supported by the head guide rails 33. The printer head 34 is driven in the primary scanning direction along the head guide rails 33 by means of drive means (not shown). In other words, the head guide rails 33 are arranged parallel to the primary scanning direction to guide a movement of the printer head 34 in the primary scanning direction.

An on-demand piezoelectric head is used as the printer head 34. The printer head 34 has a paint nozzle portion 35 for injecting the frosting paint toward the design face 1a of the base member 1 and a plurality of air nozzle portions 36 for spraying air introduced through the duct 30 (FIG. 9) onto the design face 1a. Air in the form of a laminar air curtain is injected from the air nozzle portions 36. The air nozzle portions 36 are so arranged as to surround the paint nozzle portion 35.

An ultraviolet ray radiation unit 37 for radiating ultraviolet rays onto the frosting paint applied to the design face 1a to cure the frosting paint is provided in the vicinity of the printer head 34. The ultraviolet ray radiation unit 37 is mounted to a structural component of the printer 26, for example, the cover 28, except the conveyance table 32, the head guide rails 33, and the printer head 34.

Next, a method of manufacturing a decorative member using the printing system of FIG. 9 will be described. First, the cover 28 is opened and the base member 1 is laid on the conveyance table 32 with the design face 1a facing upward. The cover 28 is then closed to seal the printer 26 hermetically. After that, purified air is introduced into the printer 26 through the duct 30.

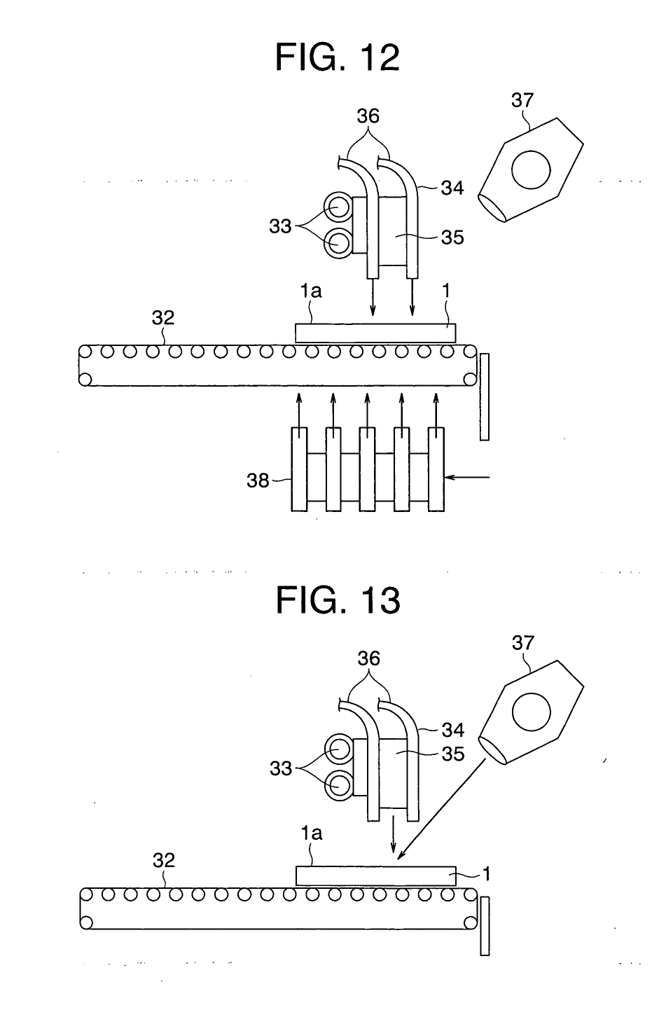

FIG. 12 is a side view showing how air is sprayed onto the base member 1 of FIG. 11. Although not shown in FIG. 11, air nozzle portions 38 are provided in the printer 26 below the conveyance table 32 as well. Thus, purified air is injected from the air nozzle portions 36 and 38 arranged at the respective locations in the hermetically sealed printer 26. At this moment, the angle at which air is sprayed can be adjusted.

The injected air is discharged from the exhaust port 27a (FIG. 9). Further, a degree of cleanness of the discharged air is monitored. When a preset degree of cleanness is maintained for a predetermined period, the introduction of air into the printer 26 is stopped or the pressure of air is automatically adjusted (reduced) by the pressure adjustment unit 31 to apply a pre-charge pressure to the interior of the printer 26 through the gradual introduction of air.

A pattern to be recorded on the design face 1a is created using graphic-type software on the computer 22. Data saved in the server 25 can be used to create the pattern.

After that, the created pattern is converted into a predetermined control signal on the computer 22. This control signal is outputted to the printer 26. When the control signal is inputted to the printer 26, the position of the printer head 34 is controlled, and the discharge amount control portion for controlling the discharge amount of the frosting paint is controlled to ensure a suitable dot diameter. Then, the pattern is printed on the design face 1a. As shown in FIG. 13, ultraviolet rays are radiated by the ultraviolet ray radiation unit 37 onto the frosting paint applied to the design face 1a, to thereby cure the frosting paint.

The transparent paint is applied using a common printer designed to selectively change the paint type. However, the transparent paint can also be applied using another printer after the frosting paint has been applied.

When the pattern is printed on the design face 1a as described above, a distance position between the centers of the dots most suited for the dot diameter is defined by the computer 22, and the pattern is processed based on information regarding this definition, utilizing error diffusion, a Dither method, or FM screening.

### Embodiment 2

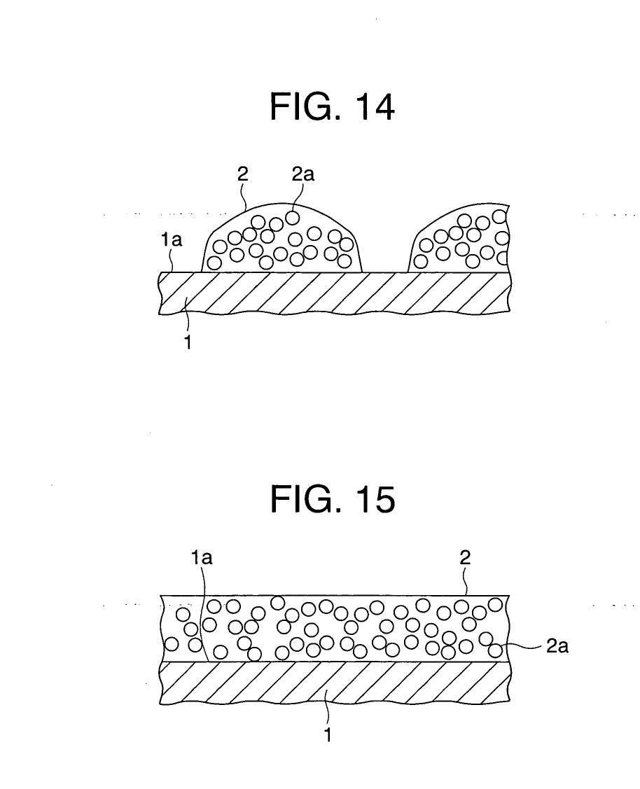

Reference is then made to FIG. 14, which is a sectional view of a decorative member according to Embodiment 2 of the present invention. In this example, a large number of bubbles 2a are formed in the frosting paint layer 2 made of the frosting paint. In other words, as the frosting paint used in Embodiment 2 cures, the bubbles 2a are generated therein to create a frosted state.

By thus using the frosting paint generating bubbles during its curing, it becomes possible to keep the surface shape of the dots smooth and prevent microscopic dirt from adhering thereto. That is, while such a frosting paint as creates a frosted state through generation of microscopic uneven regions (or crimps) on the surface during its curing may allow dirt to adhere to the uneven regions, the frosting paint of Embodiment 2 makes the adhesion of dirt relatively unlikely.

Although the dots of the frosting paint are spaced apart from one another in FIG. 14, the frosting paint may also be applied so that no space is generated among the dots as shown in, for example, FIG. 15.

### Embodiment 3

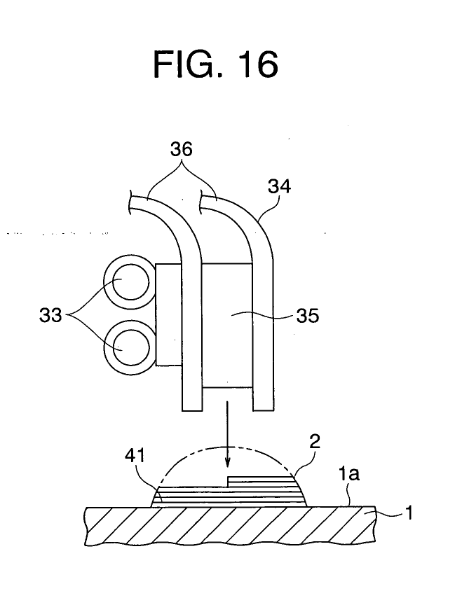

Reference is then made to FIG. 16, which is a sectional view of a decorative member according to Embodiment 3 of the present invention. In this example, the paint layer 2 is three-dimensionally formed by laminating a plurality of unit paint layers 41. The unit paint layers 41 are applied and cured one by one. In other words, after a first one of the unit paint layers 41 has been cured, a second one of the unit paint layers 41 is applied thereto.

In this manner, the three-dimensional paint layer 2 can also be formed to achieve a distinctive variation in design.

An inorganic material or an organic material can be used as the base member. Usable as the inorganic material other than metal are, for example, glass, stone, china, and ceramic. Usable as the organic material are, for example, resin and wood.

During application of the paint, the design face may be vertically erected, horizontally laid, or tilted.

Furthermore, although the paint layer is formed directly on the base member in the above-mentioned examples, a background colored layer or an antirust layer may be applied or an ink-stained colored pattern layer may be formed between the base member and the paint layer.

1. A decorative member comprising:
a base member having a design face; and
a paint layer on the design face and containing a frosting paint creating a frosted state, wherein
the frosting paint comprises a large number of dots, and
the frosting paint changes in density in a pattern on the paint layer.

2. The decorative member according to claim 1, wherein:
the paint layer includes a frosting paint region comprising the frosting paint and a transparent paint region comprising a transparent paint different from the frosting paint; and
the pattern on the paint layer comprises a combination of the frosting paint region and the transparent paint region.

3. The decorative member according to claim 1, wherein the frosting paint includes a plurality of lines spaced apart from one another.

4. The decorative member according to claim 1, wherein the frosting paint includes a plurality of curves.

5. The decorative member according to claim 1, wherein the frosting paint continuously changes in density and grades the pattern.

6. The decorative member according to claim 1, wherein the design face is polished to enhance glossiness thereof.

7. The decorative member according to claim 1, wherein the frosting paint has a dot diameter no larger than 65 μm.

8. The decorative member according to claim 1, wherein a distance between centers of adjacent dots of the frosting paint is larger than dot diameter and no larger than 300% of the dot diameter.

9. The decorative member according to claim 1, wherein a distance between centers of dots of the frosting paint gradually changes across the paint layer.

10. The decorative member according to claim 1, wherein the frosting paint creates the frosted state through bubbles therein.

11. The decorative member according to claim 1, wherein the paint layer includes three-dimensionally laminated unit paint layers.
